(19) United States
(12) Patent Application Publication
(10) Pub. No.: US 2006/0124774 A1
(43) Pub. Date: Jun. 15, 2006

(54) Fuel-injection valve

(76) Inventors: Guenter Dantes, Eberdingen (DE); Detlef Nowak, Heilbronn (DE); Joerg Heyse, Besigheim (DE)

Correspondence Address: KENYON & KENYON LLP, ONE BROADWAY, NEW YORK, NY, 10004, US

(21) Appl. No.: 10/537,843

(22) PCT Filed: Jul. 2, 2003
(86) PCT No.: PCT/DE03/02210

§ 371 Date: Nov. 14, 2005

(30) Foreign Application Priority Data
Dec. 4, 2002 (DE) 10256667.4

(51) Int. Cl. F02M 51/00

(52) U.S. Cl. 239/585.1

(57) ABSTRACT

A fuel injector for fuel-injection systems of internal combustion engines includes an excitable actuator, a valve needle, which is in operative connection with the actuator and acted upon in a closing direction by a restoring spring to actuate a valve-closure member, which, together with a valve-seat surface formed on a valve-seat body, forms a sealing seat; and having at least one spray-discharge orifice which is formed in the valve-seat body. A guide region, which is formed in the valve-seat member and in which the valve-closure member is guided, is configured in such a way that it tapers conically in a flow direction of the fuel.

### FIELD OF THE INVENTION

The present invention relates to a fuel injector.

### BACKGROUND INFORMATION

German patent document no. 198 04 463 A1, for instance, refers to a fuel-injection system for a mixture-compressing internal combustion engine having externally supplied ignition is known, which includes a fuel injector that injects fuel into a combustion chamber formed by a piston/cylinder construction and has a spark plug which projects into the combustion chamber. The fuel injector is provided with at least one row of injection orifices distributed across the circumference of the fuel injector. By a selective injection of fuel via the injection orifices, a jet-controlled combustion method is implemented by at least one jet in that a mixture cloud is formed.

A particular disadvantage of the fuel injector known from the aforementioned publication may be the deposit formation in the spray-discharge orifices. These deposits clog the orifices and cause an unacceptably high reduction in the flow rate through the injector, which leads to malfunctions of the internal combustion engine.

### SUMMARY OF THE INVENTION

The fuel injector according to the exemplary embodiment of the present invention may have the advantage that a guide region in the valve-seat body, which conically tapers in the discharge direction of the fuel, allows hydraulic self-centering of the valve-seat body on the sealing seat during closing of the fuel injector. This prevents post-sprays and thus deposits in the region of the spray-discharge orifices and prevents an unacceptable flow reduction.

Given an angle of the guide region of 2° to 7.5° with respect to the perpendicular line, spherical valve-closure members, which are able to be produced and installed very easily and inexpensively, may advantageously be used.

It is also advantageous that play existing between the valve-closure member and the valve-seat body has different magnitudes in the open and closed state of the fuel injector; this causes a slight impact pressure to build up, which leads to automatic centering of the valve-closure member.

Furthermore, it is advantageous if the sealing seat and the guide region are drilled and ground in one working step in a joint clamping, using the same axis of symmetry.

### BRIEF DESCRIPTION OF THE DRAWINGS

FIG. 1 shows a schematic section through an exemplary embodiment of a fuel injector according to the present invention.

FIG. 2 shows a schematic section through the exemplary embodiment of the fuel injector according to the present invention, in region II in FIG. 1.

### DETAILED DESCRIPTION

An exemplary embodiment of the present invention is described below by way of example. Identical parts have been provided with matching reference numerals in all of the figures.

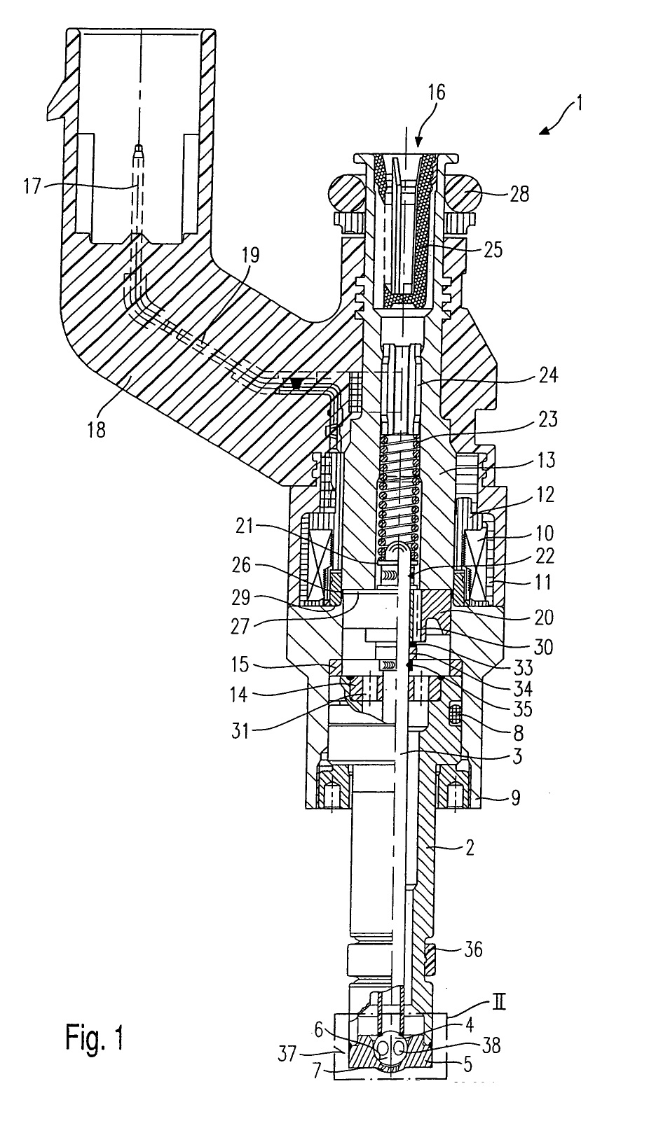

An exemplary embodiment of a fuel injector 1 according to the present invention, shown in FIG. 1, is designed in the form of a fuel injector 1 for fuel-injection systems of mixture-compressing internal combustion engines having externally supplied ignition. Fuel injector 1 is particularly suited for the direct injection of fuel into a combustion chamber (not shown) of an internal combustion engine.

Fuel injector 1 is made up of a nozzle body 2 in which a valve needle 3 is positioned. Valve needle 3 is in operative connection with a valve-closure member 4, which cooperates with a valve-seat surface 6 positioned on a valve-seat body 5 to form a sealing seat. Fuel injector 1 in the exemplary embodiment is an inwardly opening fuel injector which has at least one—in the exemplary embodiment, two—spray-discharge orifice(s) 7.

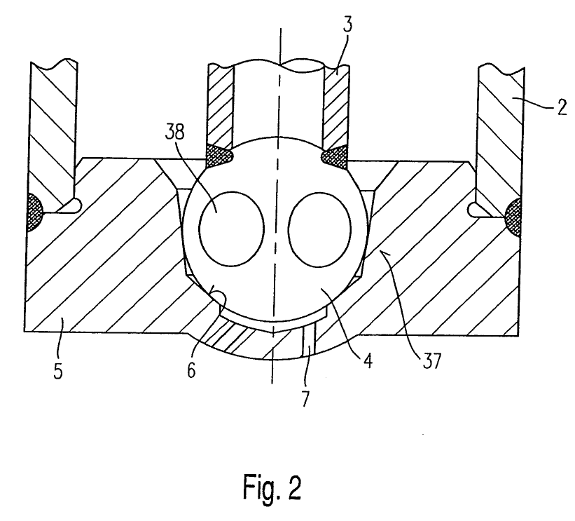

Valve-closure member 4 is guided in valve-seat body 5 by gimbals. According to the exemplary embodiment of the present invention, a guide region 37 of valve-seat body 5 has a design that tapers conically in the spray-discharge direction. Beveled sections 38 on valve-closure member 4 guide the fuel that is flowing through fuel injector 1 to the sealing seat and spray-discharge orifices 7. A detailed description of the measures according to the invention may be gathered from FIG. 2 and the specification.

Seal 8 seals nozzle body 2 from an outer pole 9 of a solenoid coil 10. Solenoid coil 10 is encapsulated in a coil housing 11 and wound on a coil brace 12, which rests against an inner pole 13 of solenoid coil 10. Inner pole 13 and outer pole 9 are separated from one another by a constriction 26 and interconnected by a non-ferromagnetic connecting part 29. Solenoid coil 10 is energized via a line 19 by an electric current, which may be supplied via an electrical plug contact 17. A plastic extrusion coat 18, which may be extruded onto inner pole 13, encloses plug contact 17.

Valve needle 3 is guided in a valve-needle guide 14, which is disk-shaped. A paired adjustment disk 15 is used to adjust the (valve) lift. Armature 20 is on the other side of adjustment disk 15. Via a first flange 21, it is in force-locking connection to valve needle 3, which is connected to first flange 21 by a welded seam 22. Braced on first flange 21 is a restoring spring 23, which is prestressed by a sleeve 24 in the present design of fuel injector 1.

Fuel channels 30, 31 and 32 run in valve-needle guide 14, armature 20 and along a guide element 36. The fuel is supplied via a central fuel supply 16 and filtered by a filter element 25. A seal 28 seals fuel injector 1 from a fuel distributor line (not shown further), and an additional seal 37 seals it from a cylinder head (not shown further).

On the spray-discharge side of armature 20 is an annular damping element 33 made of an elastomeric material. It rests on a second flange 34, which is joined to valve needle 3 by force-locking via a welded seam 35.

In the quiescent state of fuel injector 1, armature 20 is acted upon by restoring spring 23 against its direction of lift, in such a way that valve-closure member 4 is held in sealing contact on valve-seat surface 6. In response to excitation of solenoid coil 10, it generates a magnetic field that moves armature 20 in the lift direction, counter to the spring force of restoring spring 23, the lift being predefined by a working gap 27 that occurs in the rest position between inner pole 12 and armature 20. First flange 21, which is welded to valve needle 3, is taken along by armature 20, in the lift direction as well. Valve-closure member 4, being connected to valve needle 3, lifts off from valve seat surface 6, and fuel guided, via fuel channels 30 through 32, is spray-discharged through spray-discharge orifice 7.

If the coil current is interrupted, following sufficient decay of the magnetic field, armature 20 falls away from inner pole 13 due to the pressure of restoring spring 23, whereupon first flange 21, being connected to valve needle 3, moves in a direction counter to the lift direction. Valve needle 3 is thereby moved in the same direction, causing valve-closure member 4 to set down on valve seat surface 6 and fuel injector 1 to be closed.

In a part-sectional view, FIG. 2 shows the detail of fuel injector 1 configured according to the exemplary embodiment of the present invention, which is denoted by II in FIG. 1.

As already mentioned before, valve-closure member 4 is guided in valve-seat body 5 by gimbals. In general, inwardly opening fuel injectors, especially in conjunction with large seat angles, have the disadvantage that valve needle 3 does not immediately close fuel injector 1 completely after striking the sealing seat. This causes a certain fuel quantity to be post-injected, which is undesirable. Since this is still happening in the combustion phase of the fuel/air mixture in the combustion chamber, the flame front penetrates as far as the spray-discharge orifices 7. This causes an increase in deposits from combustion products in the region of spray-discharge orifices 7, resulting in clogging of spray-discharge orifices 7 and thus an unacceptably high reduction in the flow rate through fuel injector 1.

As a counter measure according to the exemplary embodiment of the present invention, a guide region 37 of valve-seat body 5 in which valve-closure member 4 is guided tapers conically in the flow direction. In this way the guide play between valve-closure member 4 and valve-seat body 5 differs in its magnitude as a function of the lift of valve needle 3. When fuel injector 1 is closed, the guide play is at its lowest and occurs in an order of magnitude of approximately 4 μm. At maximum lift of valve needle 3 in the open state of fuel injector 1, the guide play is considerably greater and amounts to 8 μm, for instance. The opening angle of conical guide region 37 may lay between 4° and 15°.

If fuel injector 1 is closed, the conicalness of guide region 37 causes hydraulic self-centering of valve-closure member 4. During its axial movement in the flow direction, valve-closure member 4 displaces fuel that is present in guide region 37. The fuel thereby accumulates since guide region 37 becomes narrower in the flow direction. As a consequence, a pressure bolster is formed in the region of the valve-closure member in guide region 37, which hydraulically centers valve-closure member 4 within guide region 37. Immediately after the closing operation, valve-closure member 4 thus seals across the entire sealing circumference at valve-seat surface 6 with respect to the sealing seat. Without this measure, valve-closure member 4 would strike valve-seat surface 6 eccentrically and be centered only after a certain period of time by the action of a closing force exerted by restoring spring 23 via valve needle 3.

For the precise centering of guide region 37, valve-seat surface 6 and guide region 37 must be drilled and ground with a shared axis of symmetry, which may be together and in one clamping in a tool machine.

The present invention is not limited to the exemplary embodiments shown, but is also applicable to any other designs of fuel injectors 1.

1-11. (canceled)

12. A fuel injector for a fuel-injection system of an internal combustion engine, comprising:
a restoring spring;
a valve closure member;
an energizable actuator;
a valve needle, which is in operative connection with the actuator and acted upon in a closing direction by the restoring spring to actuate the valve-closure member, which, together with a valve-seat surface formed on a valve-seat body, forms a sealing seat; and
at least one spray-discharge orifice, which is formed downstream from the sealing seat, wherein a guide region, which is formed in the valve-seat body and in which the valve-closure member is guided, tapers conically in a flow direction of fuel.

13. The fuel injector of claim 12, wherein the guide region is formed on an inflow side of the sealing seat.

14. The fuel injector of claim 12, wherein, as a result of the conicalness, an impact pressure prevails in the fuel that is present in the guide region.

15. The fuel injector of claim 14, wherein the impact pressure in the guide region leads to a hydraulic self-centering of the valve-closure member in the guide region.

16. The fuel injector of claim 12, wherein a cone-opening angle of the guide region is between 4° and 15°.

17. The fuel injector of claim 12, wherein guide play existing between the valve-closure member and the valve-seat body amounts to approximately 4 μm in a closed state of the fuel injector.

18. The fuel injector of claim 12, wherein guide play existing between the valve-closure member and the valve-seat body amounts to approximately 8 μm in an open state of the fuel injector.

19. The fuel injector of claim 12, wherein the valve-closure member has a spherical design.

20. The fuel injector of claim 12, wherein the valve-seat member is connected to the valve needle by welding or soldering.

21. The fuel injector of claim 12, wherein the valve-closure member has beveled sections in the guide region.

22. The fuel injector of claim 12, wherein both the guide region and the sealing seat are jointly drilled and ground with a shared axis of symmetry, in one clamping.
